(19) United States
(12) Patent Application Publication
(10) Pub. No.: US 2017/0022992 A1
(43) Pub. Date: Jan. 26, 2017

(54) PUMP SHELTER

(71) Applicant: Daniel Jutras, Québec (CA)

(72) Inventor: Daniel Jutras, Québec (CA)

(21) Appl. No.: 15/124,263

(22) PCT Filed: Mar. 9, 2015
(86) PCT No.: PCT/CA2015/050178

§ 371 Date: Sep. 7, 2016

Related U.S. Application Data
(60) Provisional application No. 61/949,428, filed on Mar. 7, 2014.

(51) Int. Cl. F04D 13/02; A62C 27/00; F04D 29/58; F04D 29/62; B62D 63/06; F04D 29/42; E04H 5/02; F16M 1/00; F16M 3/00; A62C 25/00; F04D 29/22

(52) U.S. Cl. CPC F04D 13/02; A62C 25/00; A62C 27/00; F04D 29/5893; F04D 29/628; F04D 29/22; F04D 29/4293; E04H 5/02; F16M 1/00; F16M 3/00; B62D 63/062

(57) ABSTRACT

A pump shelter including a housing, the housing having insulating structures for insulating an interior of the housing from external elements. A pump system is positioned within the housing and operable for pumping a fluid. A heating system is also positioned within the housing for heating the interior of the housing. A lighting system provides lighting for the interior of the housing. A power supply system provides power to at least one of the pump system, the heating system and the lighting system. Hose elements are removably connectable to the pump system. The pump shelter is readily and quickly available for rapid deployment in a fire or flooding scenario under various climate conditions.

### FIELD OF THE INVENTION

The present invention generally relates to fire safety and disaster clean-up. More particularly, the present invention relates to a pump shelter.

### BACKGROUND OF THE INVENTION

Dwellings or any other type of infrastructure can sometimes be in a location that is not proximate a water source or fire hydrant. This can become problematic when a fire occurs and when there is a delay in obtaining help from fire department or emergency services. Very often, the fire can propagate much faster than the travel time required for the fire department to reach the location of the fire. Moreover, once present at a site, extreme cold temperature conditions may affect the performance of equipment used to put out the fire. Such situations can lead to losses of life, and significant damages to the infrastructures affected by the fire. These damages can lead to costly claims that must be reimbursed by insurance companies.

In other scenarios, rapid or flash flooding can also require quick interventions that are also not always readily available. Having a system that can quickly provide a countermeasure to a flooding scenario could also help reduce the extent of damages and the corresponding eventual claims made to insurance companies.

Thus there is still presently a need for a pump shelter that is readily and quickly available for rapid deployment in a fire or flooding scenario under various climate conditions.

### SUMMARY OF THE INVENTION

An objective of the present invention is to provide a pump shelter that satisfies the above-mentioned need.

Accordingly, the present invention provides a pump shelter comprising:
a housing, the housing comprising insulating structures for insulating an interior of the housing from external elements;
a pump system positioned within the housing and operable for pumping a fluid;
a heating system positioned within the housing for heating the interior of the housing;
a lighting system positioned within the housing for lighting the interior of the housing;
a power supply system providing power to at least one of the pump system, the heating system and the lighting system; and
hose elements removably connectable to the pump system.

In one embodiment, the shelter further includes an air pump removably connectable to a hose element extending outside the housing and configured to circulate air through the hose element to prevent freezing of any fluids located therein.

In another embodiment, the shelter further includes a heating wire system connected to a hose element extending outside the housing and configured to heat the external hose element to prevent freezing of any fluids located therein.

In one embodiment, the power supply system includes a removable fuel reservoir removably connected to the pump system.

In certain embodiments, the power supply system includes an external power supply interface for connecting the power supply system to an external power supply.

In certain embodiments, a displacement system can be provided for supporting the housing and contents of the housing, and providing displacement means for displacing the pump shelter from one location to another.

Preferably, the displacement system is a wheeled trailer.

In certain embodiments, the insulating structures include polyurethane inner insulation.

### BRIEF DESCRIPTION OF THE DRAWINGS

These and other objects and advantages of the invention will become apparent upon reading the detailed description and upon referring to the drawings in which:

FIG. 1 is a perspective view of a pump shelter according to an embodiment of the present invention, in an open configuration;

FIG. 2 is a perspective view of a pump shelter according to an embodiment of the present invention, in a closed configuration;

FIGS. 3A to 3D are perspective views of a pump shelter on a trailer according to an embodiment of the present invention;

FIG. 4 is a perspective view of an electrical panel according to an embodiment of the present invention;

FIG. 5 is a perspective view of a pump system according to an embodiment of the present invention;

FIG. 6 is a perspective view of a polyurethane interior panel according to an embodiment of the present invention;

FIG. 7 is a perspective view of an electrical box according to an embodiment of the present invention;

FIG. 8 is a perspective view of an outlet according to an embodiment of the present invention;

FIG. 9 is a perspective view of an outlet plate according to an embodiment of the present invention;

FIG. 10 is a perspective view of a fuel reservoir according to an embodiment of the present invention;

FIG. 11 is a perspective view of a battery charger according to an embodiment of the present invention;

FIG. 12 is a perspective view of an electrical box according to an embodiment of the present invention;

FIG. 13 is a perspective view of a light socket according to an embodiment of the present invention;

FIG. 14 is a front view of a light bulb according to an embodiment of the present invention;

FIG. 15 is a perspective view of an electrical heater according to an embodiment of the present invention;

FIG. 16 is a perspective view of a 1½″ diameter hose according to an embodiment of the present invention;

FIG. 17 is a perspective view of a 2½″ diameter hose according to an embodiment of the present invention;

FIG. 18 is a perspective view of a hose adapter according to an embodiment of the present invention;

FIG. 19 is a perspective view of an air pump according to an embodiment of the present invention;

FIG. 20 is a perspective view of a pressure gauge according to an embodiment of the present invention;

FIG. 21 is a perspective view of a solenoid valve according to an embodiment of the present invention;

FIG. 22 is a perspective view of an air regulator according to an embodiment of the present invention;

FIG. 23 is a perspective view of a spray nozzle according to an embodiment of the present invention;

FIG. 24 is a perspective view of a pump shelter according to an embodiment of the present invention;

FIG. 25 is a perspective view of an instruction sticker according to an embodiment of the present invention;

FIG. 26 is a perspective view of an instruction sticker according to an embodiment of the present invention;

FIG. 27 is a perspective view of a pipe and connector for connecting the air regulator to the venturi according to an embodiment of the present invention;

FIG. 28 is a perspective view of a rubber pipe for evacuating water from the venturi according to an embodiment of the present invention;

FIG. 29 is a perspective view of protective tubing for wiring according to an embodiment of the present invention;

FIG. 30 is a perspective view of a support clip for a pump frame according to an embodiment of the present invention;

FIG. 31 is a perspective view of neoprene seal around a door frame according to an embodiment of the present invention;

FIG. 32 is a perspective view of steel plate for supporting an air compressor according to an embodiment of the present invention;

FIG. 33 is a perspective view of a handle for a door of the pump shelter according to an embodiment of the present invention;

FIG. 34 is a perspective view of a pump shelter in an open configuration according to an embodiment of the present invention;

FIG. 35 is a perspective view of a pump shelter on a trailer according to an embodiment of the present invention;

FIG. 36 is a perspective view of a trailer according to an embodiment of the present invention;

FIG. 37 is a perspective view of a trailer accessory according to an embodiment of the present invention;

FIG. 38 is a perspective view of a pump shelter according to another embodiment of the present invention;

FIG. 39 is another perspective view of the pump shelter shown in FIG. 38;

FIG. 40 is another perspective view of the pump shelter shown in FIG. 38;

FIG. 41 is another perspective view of the pump shelter shown in FIG. 38;

FIG. 42 is a perspective view of the interior of the pump shelter shown in FIG. 38;

FIG. 43 is another perspective view of the interior of the pump shelter shown in FIG. 38; and

FIG. 44 is a schematic view of a positioning of a pump shelter with respect to a body of water.

### DESCRIPTION OF AN EMBODIMENT

In the following description, the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional, and are given for exemplification purposes only.

Furthermore, although the present invention may be used with a pump housing in fire or flooding scenarios for example, it is understood that it may be used in other types of scenarios, for other purposes. For this reason, expressions such as “pump shelter”, etc. as used herein should not be taken as to limit the scope of the present invention to being used with a pump shelter in particular. These expressions encompass all other kinds of materials, objects and/or purposes with other types of pump shelters with which the present invention could be used and may be useful.

In addition, although the optional configurations as illustrated in the accompanying drawings comprises various components and although the optional configurations of pump shelter as shown may consist of certain geometrical configurations as explained and illustrated herein, not all of these components and geometries are essential and thus should not be taken in their restrictive sense, i.e. should not be taken as to limit the scope of the present disclosure. It is to be understood that other suitable components and cooperations thereinbetween, as well as other suitable geometrical configurations may be used for the pump shelter, and corresponding parts, as briefly explained and as can be easily inferred herefrom, without departing from the scope of the disclosure.

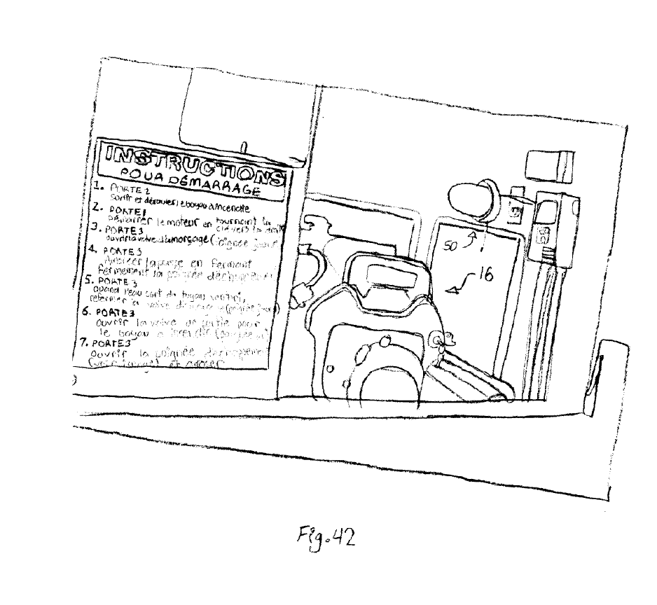

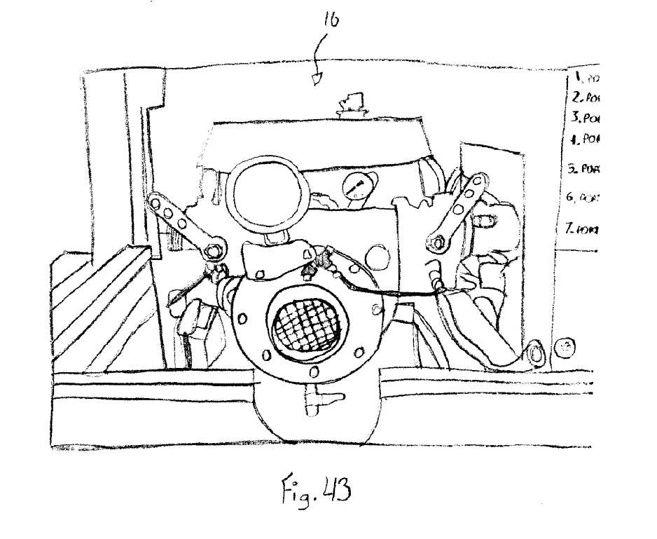

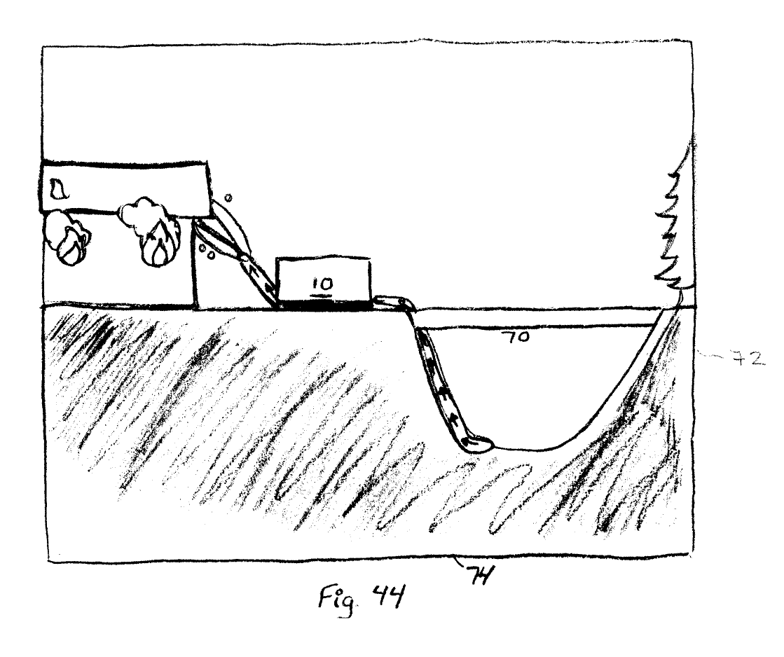

As shown in FIGS. 1 and 2, the present invention provides a pump shelter 10 including a housing 12. The housing 12 has insulating structures 14 for insulating an interior of the housing 12 from external elements. As better shown in FIG. 6, the insulating structures can include polyurethane interior covering, preferably 2″ thick. A pump system 16 is positioned within the housing 12 and operable for pumping a fluid. A heating system 18 is also positioned within the housing 12 for heating the interior of the housing. A lighting system 50, including components shown in FIGS. 12 to 14, provides lighting for the interior of the housing. A power supply system 20 provides power to at least one of the pump system 16, the heating system 18 and the lighting system. Hose elements 22 are removably connectable to the pump system.

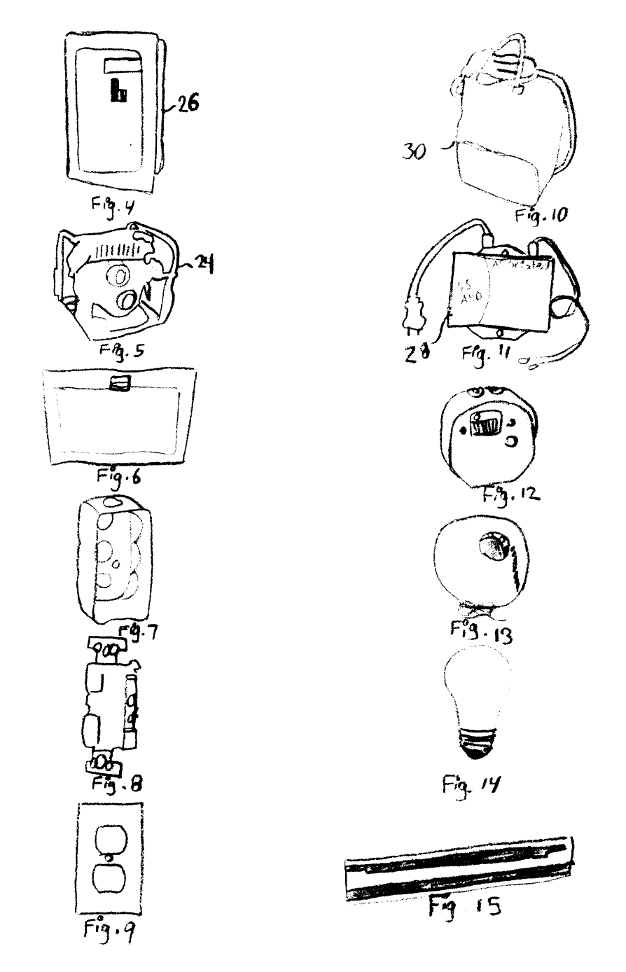

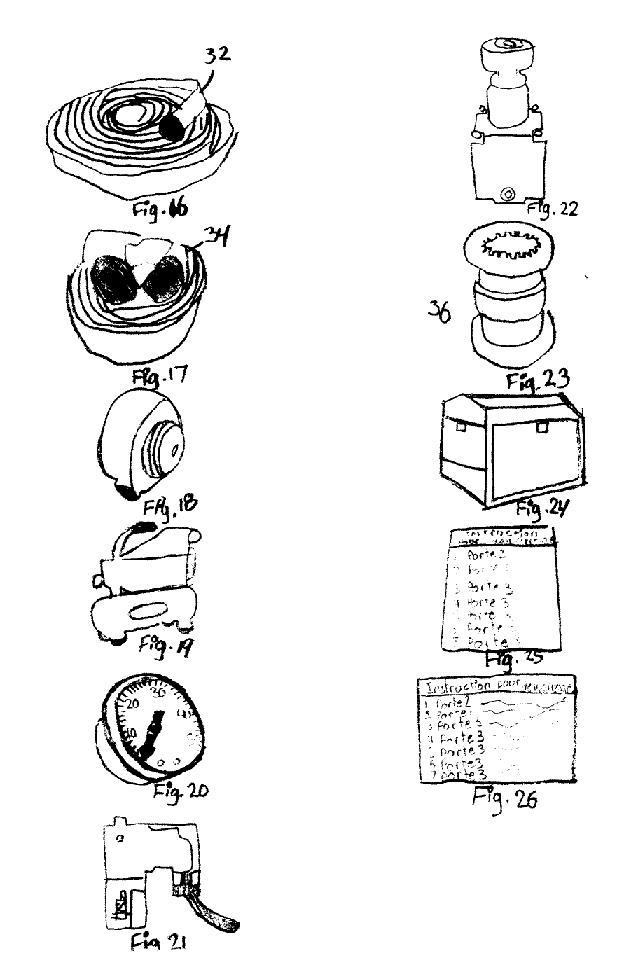

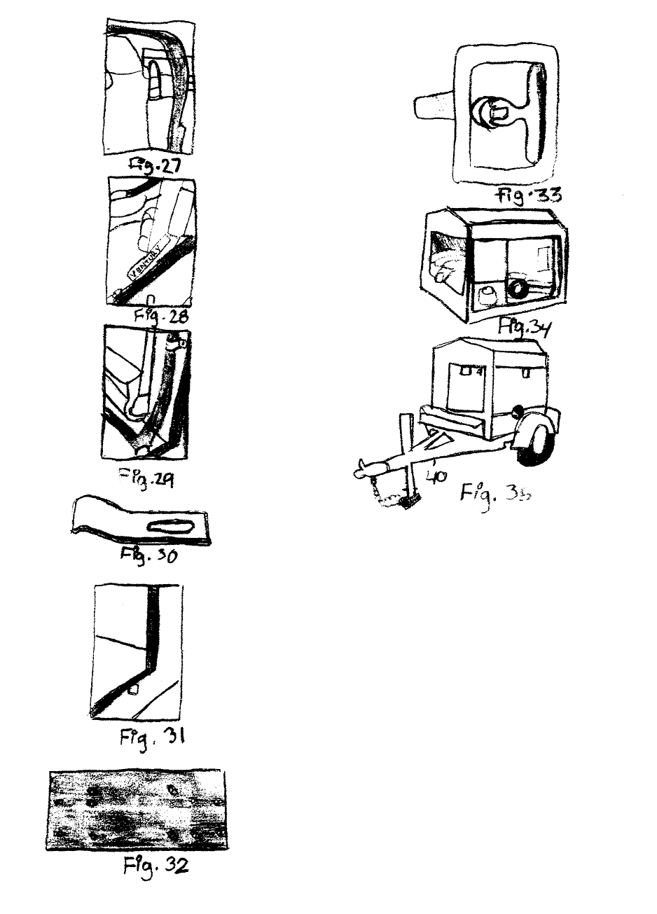

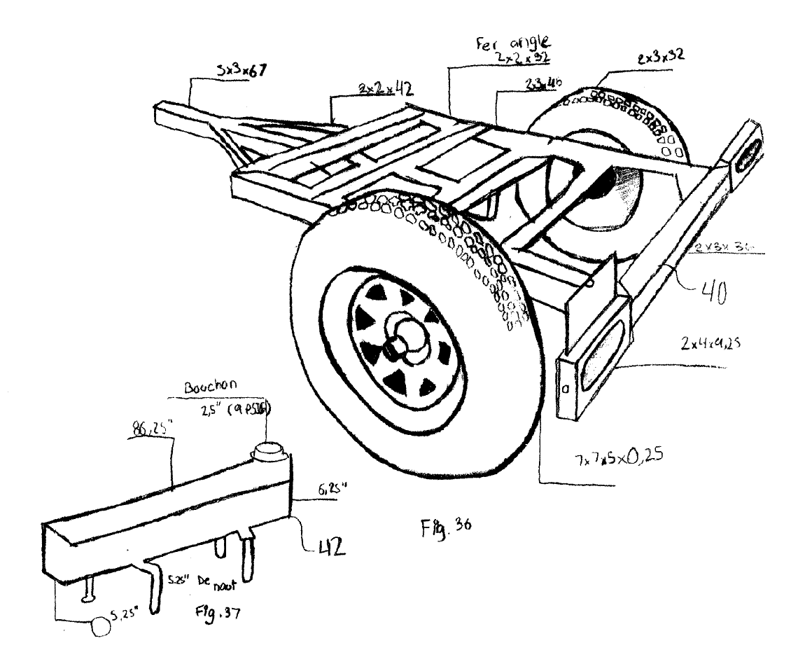

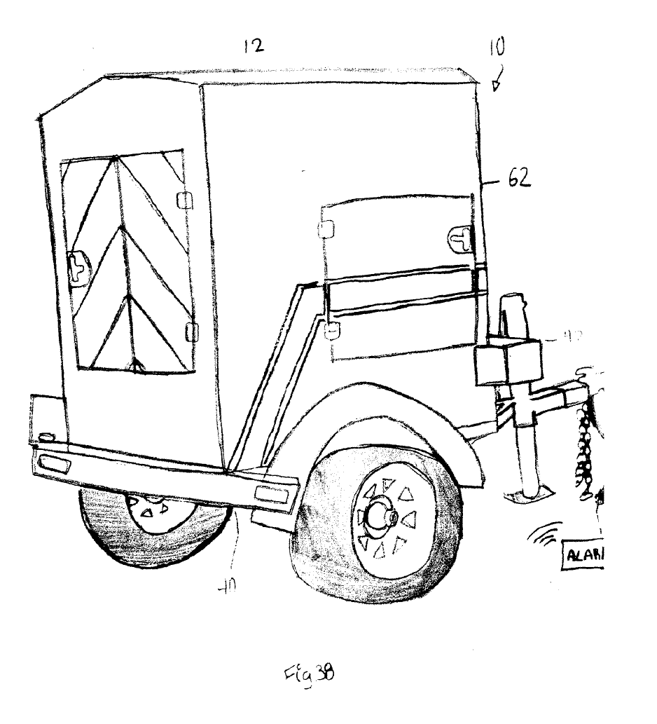

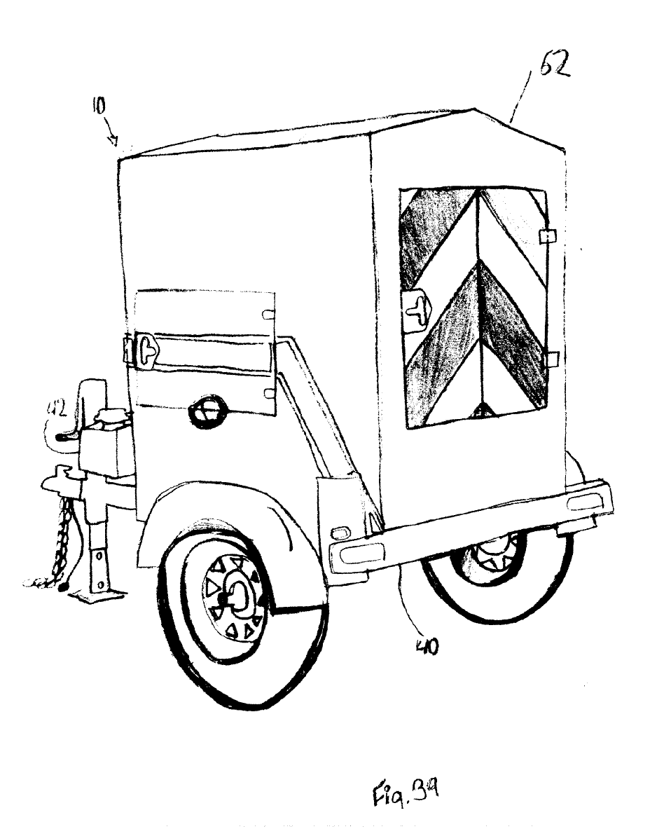

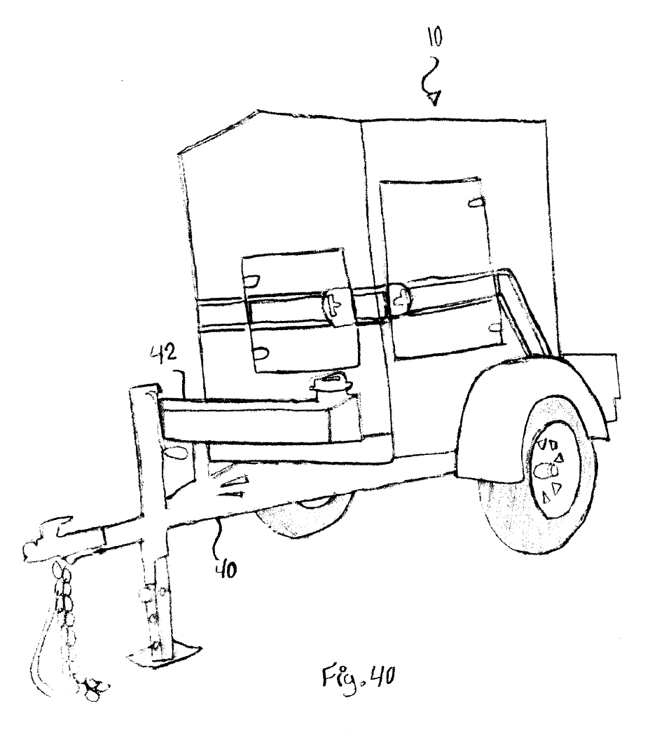

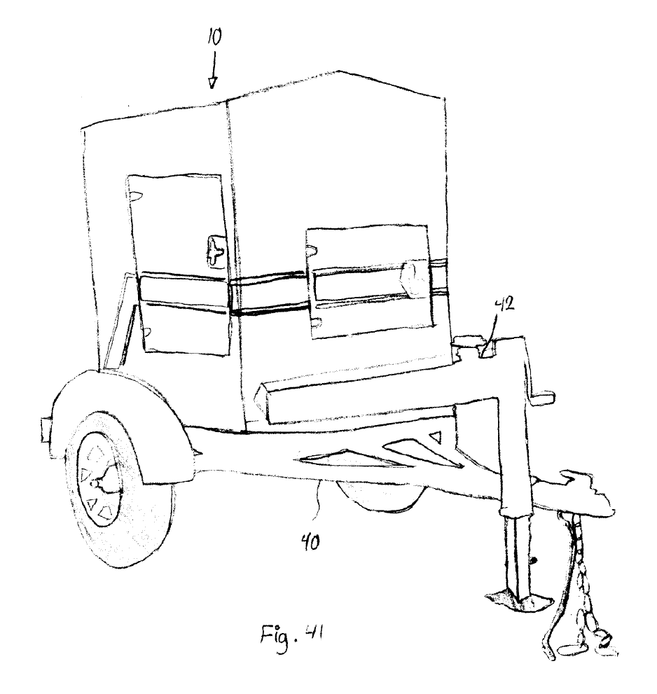

The pump shelter 10 is thus an insulated, heated and lit shelter housing a high-flow water pump 24, as better shown in FIG. 5 (the pump is preferably fuel powered) with its own electrical panel 26 (as better shown in FIG. 4) and an electrical battery charger 28 (as better shown in FIG. 11) for recharging the water pump battery. Preferably, the shelter also houses a fuel reservoir 30 connected to the water pump.

Preferably, the hose elements 32,34 as shown in FIGS. 16 and 17, are connectable to spray nozzles 36.

The shelter keeps its internal components, if required, warm in cold climate conditions thus facilitating proper powering up of the pump system in a fire or flooding scenario. Preferably, the battery charger 28 ensures that the pump system is in a proper charged state upon powering up. Preferably, the fuel reservoir 30 is removable, thus allowing a quicker refill or replacement.

Preferably, the hose elements 32,34 are properly arranged and stacked within the housing is a specially-designed sub-housing. A user of the shelter can thus quickly choose a desired length of hose for use.

In an optional embodiment of the present invention, the shelter can further include an air pump removably connectable to a hose element extending outside the housing and configured to circulate air through the hose element to prevent freezing of any fluids located therein. Components related to the air pump are shown in FIG. 19 (air pump), FIG. 20 (pressure gauge), FIG. 21 (solenoid valve) and FIG. 22 (high precision air regulator).

In another optional embodiment of the present invention not illustrated, there can be provided a heating wire system connected to a hose element extending outside the housing and configured to heat the external hose element to prevent freezing of any fluids located therein.

In an embodiment of the present invention, the power supply system includes an external power supply interface for connecting the power supply system to an external power supply. Wire and cable connections can be protected through protective tubing as shown in FIG. 29.

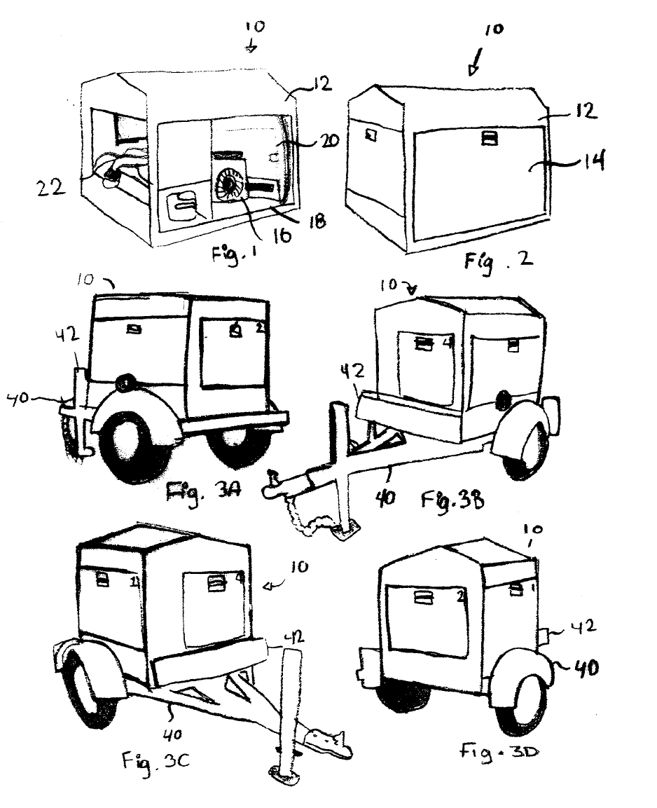

In an implementation of the present invention, the shelter further includes a displacement system supporting the housing and contents of the housing, and providing displacement means for displacing the pump shelter from one location to another. Preferably, as shown in FIGS. 3A to 3D and 36-37, the displacement system is a wheeled trailer 40. The trailer can thus be used to configure the pump shelter and its contents to be offered through rental services or for disaster/flooding clean-up support activities.

Preferably, as shown in FIG. 4, the electrical panel is a 100 A panel with 4 15 A circuits.

Preferably, as shown in FIG. 5, the water pump is a CET.PFP-20HPKHL-2D fire pump with the following specifications:

### Engine Specifications

Kohler 20 hp at 3600 RPM, air cooled engine.
V-Twin cylinder gasoline engine.
Electric start with recoil start as backup.
6 gallon (22 I) detachable fuel tank.

### Pump Unit Specifications

C.E.T. single stage centrifugal pump.
Pump body made from high resistance aluminum alloy.
Bronze impeller.
Mechanical shaft seal.
Exhaust priming system, guaranteed up to 20′ (6 meter) lift.
Two 2½″ (65 mm) delivery outlets with ¼-turn ball valve.
One 4″ (100 mm) suction inlet.
Dimensions: Length: 21¼″ (540 mm)
Width: 26½″ (673 mm); Height: 24″ (610 mm).
Weight: 194 lbs (88 kg).

### Included Accessories

Swivel spotlight.
180 watts alternator.
Pressure gauge.
12-V battery.

Preferably, as shown in FIGS. 7 to 9, the shelter can include an electrical outlet.

Preferably, as shown in FIG. 10, the fuel reservoir is a 25 liter reservoir connectable to the fire pump.

Preferably, as shown in FIG. 11, the battery charger is a 12V, 15 A charger.

Preferably, as shown in FIGS. 12 to 14, the shelter can include a light.

Preferably, as shown in FIG. 15, the heating system includes a 240V, 500 watt heating element with an integrated thermostat.

Preferably, as shown in FIG. 16, one of the hose elements is a 1½″ hose that is 50 ft long with a 1½×1¾″ coupling with a NPSH standard thread.

Preferably, as shown in FIG. 17, one of the hose elements is a 2½″ hose that is 50 ft long with a 2½×1 11/16″ coupling with a QST standard thread.

Preferably, as shown in FIG. 18, the shelter can include a coupling adapter between a 2½″ female coupling and a 1½″ male coupling with a NPSH standard thread.

Preferably, as shown in FIG. 19, the air pump or compressor is a 1.5 HP air compressor.

Preferably, as shown in FIG. 20, the pressure gauge is a 0-30 lb air pressure gauge.

Preferably, as shown in FIG. 21, the solenoid valve is a 12V solenoid valve for example a NASS Magnet 0050 00.1-00/4981 Air Max 78.2442 model.

Preferably, as shown in FIG. 22, the air regulator is a high precision 1.5-30 psi air regulator.

Preferably, as shown in FIG. 23, the spray nozzle is a 1½″ fitting copper nozzle with NPSH thread, for example a model #AK-MK15.

Preferably, as shown in FIG. 24, the housing is made from 16 gauge steel with a sand blast finish with a 2 layer aluminum/zinc covering and 1 layer of polyurethane paint.

Preferably, as shown in FIGS. 25, 26 and 42, stickers with start-up instructions can be provided behind any of the doors giving access to the interior of the housing

Preferably, as shown in FIG. 27, a pipe and cup connector for connecting the air regulator to the venturi can be provided.

Preferably, as shown in FIG. 28, a 1″ diameter×20″ long rubber pipe for evacuating water from the venturi can be provided

Preferably, as shown in FIG. 29, protective tubing made of ⅝ galvanized steel can be included for wiring or cables connecting different electrical components.

Preferably, as shown in FIG. 30, a 5½×1½×¼″ sized support for affixing the pump system in the housing can be provided.

Preferably, as shown in FIG. 31, ⅝×⅛″ neoprene seals can be provided to seal the door elements of the casing.

Preferably, as shown in FIG. 32, a 21×10×⅛″ steel plate can be provided to support the air pump or compressor.

Preferably, as shown in FIG. 33, EBERHARD model 8000-R and L gaskets and handles can be provided for the door elements of the housing.

Preferably, as shown in FIGS. 35 to 37, the trailer 40 is made from 3/16 steel tubes on a 3500 lb rated wheel shaft including a 7500 lb-rated foot lever with a 2 inch foot as well as chains and links. The wheels are 14″ wheels with protective wings, electrical cables, traffic lights and further including a 30 liter fuel tank 42 (as better shown in FIG. 37).

FIGS. 38 to 43 show a pump shelter according to another embodiment of the present invention. In this embodiment, the housing 12 is made of aluminum. Access doors 62 are hingedly connected to the housing 12. Moreover, the pump 16 can be started automatically upon receiving a start signal from a controller linked to a fire and/or alarm control panel. Typically, connection to the controller is done through a 12V connection. However, any known connection means, including a wireless connection, can be used to transmit the signal indicative of a fire alarm condition and start an automatic pump activation sequence, including starting the motor, initiating the pump and opening the fluid distribution valve.

FIG. 44 is a schematic representation of a positioning of a pump shelter 10 with respect to a body of water 72. In cold climates, any inlet for a feed line 74 connected to the pump shelter 10 should be positioned at a depth well below the known average level where ice 70 forms on the body of water 72 in freezing conditions. Positioning elements can be provided to affix the positioning of the feed line at the bottom of the body of water 72.

Although preferred embodiments of the present invention have been described in detail herein and illustrated in the accompanying drawings, it is to be understood that the invention is not limited to these precise embodiments and that various changes and modifications may be effected therein without departing from the scope of the disclosure.

1-11. (canceled)

12. A pump shelter comprising:
a housing, the housing comprising insulating structures for insulating an interior of the housing from external elements;
a pump system positioned within the housing and operable for pumping a fluid;
a heating system positioned within the housing for heating the interior of the housing;
a lighting system positioned within the housing for lighting the interior of the housing;
a power supply system providing power to at least one of the pump system, the heating system and the lighting system; and
a plurality of hose elements removably connectable to the pump system.

13. The pump shelter according to claim 12, further comprising an air pump removably connectable to a hose element of the plurality of hose elements extending outside the housing and configured to circulate air through the external hose element to prevent freezing of any fluids located therein.

14. The pump shelter according to claim 12, further comprising a heating wire system connected to a hose element of the plurality of hose elements extending outside the housing and configured to heat the external hose element to prevent freezing of any fluids located therein.

15. The pump shelter according to claim 12, wherein the power supply system comprises a removable fuel reservoir removably connected to the pump system.

16. The pump shelter according to claim 12, wherein the power supply system comprises an external power supply interface for connecting the power supply system to an external power supply.

17. The pump shelter according to claim 12, further comprising a displacement system supporting the housing and contents of the housing, and providing displacement means for displacing the pump shelter from one location to another.

18. The pump shelter according to claim 17, wherein the displacement system is a wheeled trailer.

19. The pump shelter according to claim 12, wherein the insulating structures comprise polyurethane inner insulation.

20. The pump shelter according to claim 12, further comprising a pump system start controller starting an automatic pump activation sequence of the pump system upon receipt of a signal indicative of a fire alarm condition.

21. The pump shelter according to claim 20, wherein the signal indicative of the fire alarm condition is provided through a 12V connection to a fire/alarm control panel.

22. The pump shelter according to claim 12, further comprising a hose element of the plurality of hose elements extending outside the housing and connected to the pump for feeding fluid thereto, the external hose element having an inlet affixed at a bottom of a body of water below average ice forming levels for said body of water in freezing conditions.

23. The pump shelter according to claim 13, further comprising a pump system start controller starting an automatic pump activation sequence of the pump system upon receipt of a signal indicative of a fire alarm condition.

24. The pump shelter according to claim 14, further comprising a pump system start controller starting an automatic pump activation sequence of the pump system upon receipt of a signal indicative of a fire alarm condition.

25. The pump shelter according to claim 22 further comprising a pump system start controller starting an automatic pump activation sequence of the pump system upon receipt of a signal indicative of a fire alarm condition.

26. The pump shelter according to claim 13, wherein the power supply system comprises a removable fuel reservoir removably connected to the pump system.

27. The pump shelter according to claim 14, wherein the power supply system comprises a removable fuel reservoir removably connected to the pump system.

28. The pump shelter according to claim 26, further comprising a pump system start controller starting an automatic pump activation sequence of the pump system upon receipt of a signal indicative of a fire alarm condition.

29. The pump shelter according to claim 27, further comprising a pump system start controller starting an automatic pump activation sequence of the pump system upon receipt of a signal indicative of a fire alarm condition.

30. The pump shelter according to claim 28, wherein the signal indicative of the fire alarm condition is provided through a 12V connection to a fire/alarm control panel.

31. The pump shelter according to claim 29, wherein the signal indicative of the fire alarm condition is provided through a 12V connection to a fire/alarm control panel.
